(19) United States
(12) Patent Application Publication
(10) Pub. No.: US 2002/0154103 A1
(43) Pub. Date: Oct. 24, 2002

(54) Electrooptic device and driving method thereof

(76) Inventor: Atsunari Tsuda, Suwa-shi (JP)

Correspondence Address: OLIFF & BERRIDGE, PLC, P.O. BOX 19928, ALEXANDRIA, VA, 22320, US

(21) Appl. No.: 09/937,561

(22) PCT Filed: Jan. 29, 2001
(86) PCT No.: PCT/JP01/00591

(30) Foreign Application Priority Data
Jan. 31, 2000 (JP) 2000-022909

(51) Int. Cl. G09G 5/00

(52) U.S. Cl. 345/204

(57) ABSTRACT

In providing an electro-optical apparatus with an improved visibility of image in the peripheral region of the active display area, and a method of driving the same, a mask signal generating circuit 12 constantly outputs a mask signal for displaying white. A mask controlling circuit 16 usually outputs a control signal MS for turning on an analog switch 14 and turning off an analog switch 13. Thus, a display signal VS on a terminal 10 is supplied to a display signal line 5 via the analog switch 14, whereby an image is displayed on a display panel 1. Also, the mask controlling circuit 16, based on a data line driving signal and a scanning line driving signal supplied from a timing pulse generating circuit 7, detects the timing for driving each of predetermined pixels in the peripheral region of the display panel 1, and outputs at the timing a control signal MS for turning off the analog switch 14 and turning on the analog switch 13. Thus, white is displayed in the peripheral region of the active display area.

### TECHNICAL FIELD

The present invention relates to electro-optical apparatuses such as liquid crystal display apparatuses, and more particularly, it relates to an electro-optical apparatus in which the display status in the peripheral region of the display screen is improved, and a method of driving the same.

### BACKGROUND ART

For example, in a transmission-type liquid crystal display apparatus, in order to prevent light leakage of the transmitted light (backlight), a frame-shaped light-blocking film is formed in the peripheral region of pixels on the device substrate, using a black matrix, etc. constituting color filters. The region where images such as characters and pictures are actually displayed, i.e., the so-called active display area, is defined by the light-blocking film. However, when the region where the light-blocking film is formed is visually observed, as shown in FIG. 9, the region G looks as fringed in black on the screen. Thus, for example, if a character “E” is displayed at the edge of the active display area L, part of the character overlaps the region of the light-blocking film and becomes indistinguishable, causing the problem that the visibility of the character is considerably degraded.

The present invention has been made in view of the situation, and an object thereof is to provide an electro-optical apparatus with an improved visibility of image particularly in the peripheral region of the active display area, and a method of driving the same.

### DISCLOSURE OF THE INVENTION

In order to solve the above-described problem, the present invention is an electro-optical apparatus which comprises a display panel comprising a plurality of pixels, and driving means for driving each of the pixels of the display panel based on a display signal which is externally supplied, characterized by comprising timing detection means for detecting the timing for driving the pixels in the peripheral region of the display panel, and display control means for outputting a signal for displaying a particular color to the driving means at the timing detected by the timing detection means.

In accordance with the construction, for example, white is displayed as the particular color in the periphery of the active display area of the display panel. Accordingly, the visibility in the peripheral region of the active display area can be significantly improved compared with the conventional art.

Also, the present invention is an electro-optical apparatus which comprises a display panel comprising a plurality of pixels, and driving means for driving each of the pixels based on display data which is externally supplied corresponding to each of the pixels of the display panel, characterized by comprising display control means for outputting to the driving means display data for displaying a particular color as display data for displaying each of the pixels in the peripheral region of the display panel.

In accordance with the construction, similarly to the above-described invention, the visibility in the peripheral region of the active display area can be significantly improved.

Also, the present invention is an electro-optical apparatus which comprises a display panel comprising a plurality of pixels, a memory which stores display data corresponding to each of the pixels of the display panel, writing means for writing to the memory display data which is externally supplied, and driving means for driving each of the pixels based on the display data in the memory, characterized by comprising display control means for writing to the memory display data for displaying a particular color as display data for displaying each of the pixels in the peripheral region of the display panel.

In accordance with the construction, similarly to the above-described inventions, the visibility in the peripheral region of the active display area can be significantly improved.

Also, the present invention is an electro-optical apparatus which comprises a display panel comprising a plurality of pixels, a memory which stores display data corresponding to each of the pixels of the display panel, writing means for writing to the memory display data which is externally supplied, and driving means for driving each of the pixels based on the display data in the memory, characterized in that display data for displaying a particular color is stored in advance in a storage area of the memory corresponding to each of the pixels in the peripheral region of the display panel.

In accordance with the construction, similarly to the above-described inventions, the visibility in the peripheral region of the active display area can be significantly improved. In addition, in accordance with the construction, the construction of the writing means for writing data to the memory can be simplified.

Furthermore, in the above-described inventions, each of the pixels is characterized by being composed of liquid crystal.

Furthermore, in the above-described inventions, the particular color is preferably white. Thus, the visibility in the peripheral region of the active display area can be further improved compared with other colors.

Also, the present invention is a method of driving an electro-optical apparatus which comprises a display panel comprising a plurality of pixels, and driving means for driving each of the pixels of the display panel based on a display signal which is externally supplied, characterized in that the timing for driving the pixels in the peripheral region of the display panel is detected, and in that a signal for displaying a particular color is output to the driving means at the detected timing.

In accordance with the method, for example, white is displayed as the particular color in the periphery of the active display area of the display panel. Accordingly, the visibility in the peripheral region of the active display area can be significantly improved compared with the conventional art.

Also, the present invention is a method of driving an electro-optical apparatus which comprises a display panel comprising a plurality of pixels, and driving means for driving each of the pixels based on display data which is externally supplied corresponding to each of the pixels of the display panel, characterized in that display data for displaying a particular color is output to the driving means as display data for displaying each of the pixels in the peripheral region of the display panel.

In accordance with the method, similarly to the method of the above-described invention, the visibility in the peripheral region of the active display area can be significantly improved.

Also, the present invention is a method of driving an electro-optical apparatus which comprises a display panel comprising a plurality of pixels, a memory which stores display data corresponding to each of the pixels of the display panel, writing means for writing to the memory display data which is externally supplied, and driving means for driving each of the pixels based on the display data in the memory, characterized in that display data for displaying a particular color is written to the memory as display data for displaying each of the pixels in the peripheral region of the display panel.

In accordance with the method, similarly to the methods of the above-described inventions, the visibility in the peripheral region of the active display area can be significantly improved.

In the above-described methods, the particular color is preferably white. Thus, the visibility in the peripheral region of the active display area can be further improved compared with other colors.

### BRIEF DESCRIPTION OF THE DRAWINGS

FIG. 1 is a block diagram showing the construction of a first embodiment of the present invention.

FIG. 2 is a timing diagram for explaining the operation of the embodiment.

FIG. 3 is a timing diagram for explaining the operation of the embodiment.

FIG. 4 is an illustration showing a display status of a display panel 1 in the embodiment.

FIG. 5 is a block diagram showing the construction of a second embodiment of the present invention.

FIG. 6 is a timing diagram for explaining the operation of the embodiment.

FIG. 7 is a timing diagram for explaining the operation of the embodiment.

FIG. 8 is perspective views showing examples of application of the present invention.

FIG. 9 is an illustration for explaining a problem regarding display in a conventional liquid crystal display apparatus.

### MODE FOR CARRYING OUT THE INVENTION

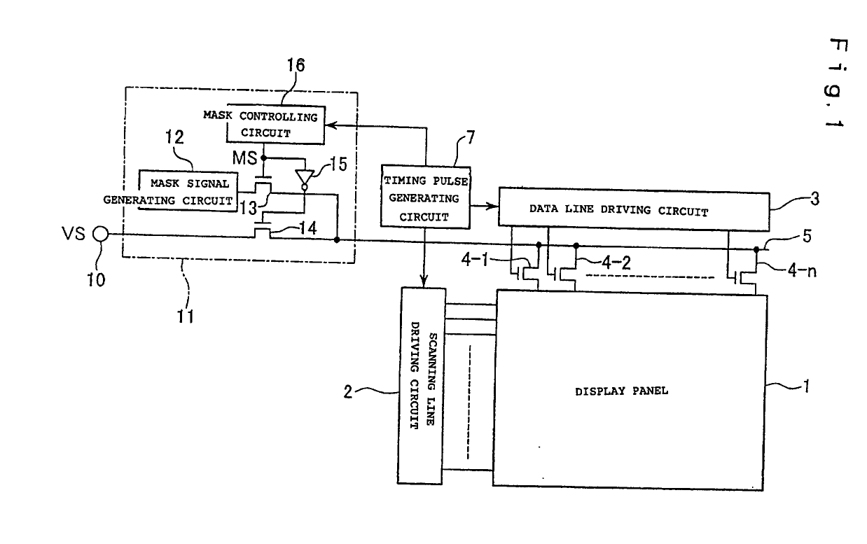

Embodiments of the present invention will be described below with reference to the drawings. FIG. 1 is a block diagram showing the construction of a liquid crystal display apparatus according to a first embodiment of the present invention. Referring to the figure, the numeral 1 is a liquid crystal display panel of the active matrix type, 2 is a scanning line driving circuit for driving the scanning lines of the display panel 1, and 3 is a data line driving circuit for driving the data lines of the display panel 1. 4-1, 4-2 . . . 4-n are analog switches, the source of each of the analog switches 4-1 to 4-n being connected to a display signal line 5, the drain thereof being connected to the data line of the display panel 1, and the gate thereof being connected to the data line driving circuit 3.

7 is a timing pulse generating circuit, which generates a scanning line driving signal and a data line driving signal based on system clock pulses and outputs respectively to the scanning line driving circuit 2 and the data line driving circuit 3.

Under the construction as above, the scanning line driving circuit 2 initially outputs a “H (high)” level signal to the first scanning line (the uppermost scanning line). Then, the data line driving circuit 3 sequentially turns on the analog switches 4-1, 4-2 . . . Thus, a display signal (analog signal) on the display signal line 5 is sequentially written to each of the pixels on the first line of the display panel 1. Next, the scanning line driving circuit 2 outputs a “H” level signal to the second scanning line of the display panel 1, and then, the data line driving circuit 3 sequentially turns on the analog switches 4-1, 4-2, . . . Thus, the display signal on the display signal line 5 is sequentially written to each of the pixels on the second line of the display panel 1. Thereafter, the display signal is sequentially written to each of the pixels of the display panel 1 by a similar procedure, whereby an image is displayed. The above-described construction has conventionally been known.

Next, referring to FIG. 1, the numeral 10 is a terminal to which a display signal (analog signal), which is externally supplied, is supplied, and 11 is a white display circuit (display controlling means). The white display circuit 11 is a circuit for displaying white in the peripheral region of the active display area of the display panel 1, and includes a mask signal generating circuit 12, analog switches 13 and 14, an inverter 15, and a mask controlling circuit 16.

The mask signal generating circuit 12 constantly outputs an analog voltage (referred to as a mask signal) for displaying white. The mask controlling circuit 16 usually outputs a control signal MS for turning on the analog switch 14 and turning off the analog switch 13. Thus, a display signal VS on the terminal 10 is supplied to the display signal line 5 via the analog switch 14, whereby an image is displayed on the display panel 1. Also, the mask controlling circuit 16, based on the data line driving signal and the scanning line driving signal supplied from the timing pulse generating circuit 7 which is timing detection means, detects the timing for driving each of predetermined pixels in the peripheral region of the display panel 1, and outputs at the timing a control signal MS for turning off the analog switch 14 and turning on the analog switch 13.

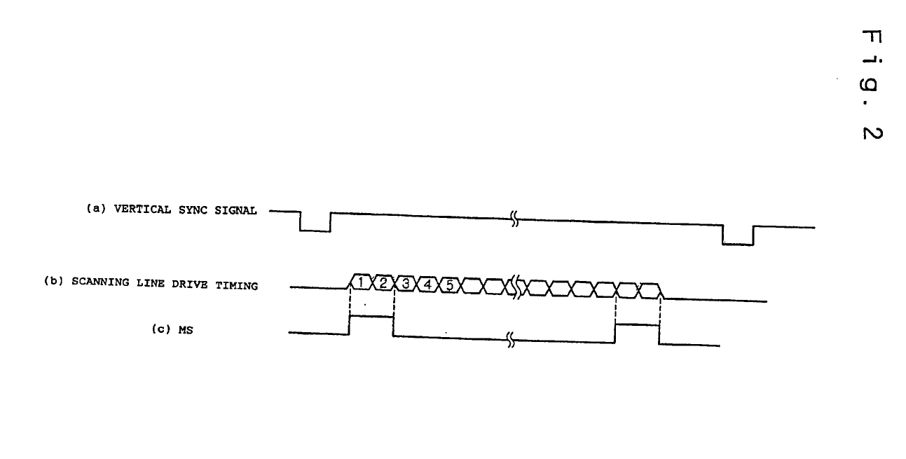

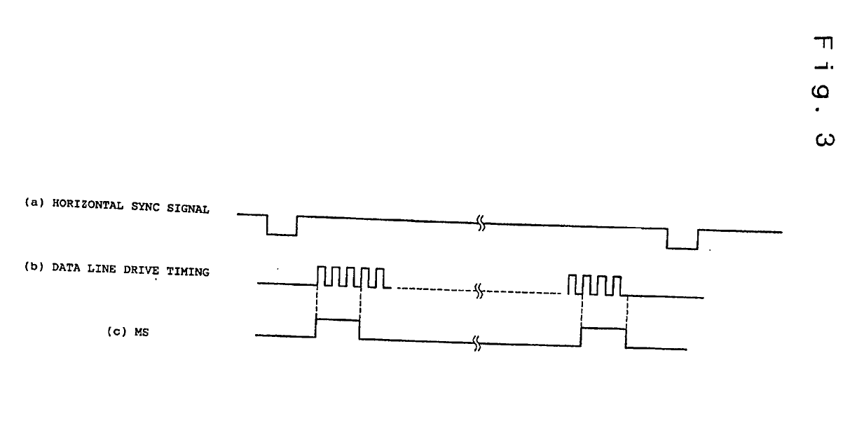

More specifically, referring to FIG. 2,(a) is the vertical sync signal, and (b) is the scanning line drive timing. The numerals 1, 2, . . . in FIG. 2 (b) indicate numbers of the scanning lines. The mask controlling circuit 16 outputs the control signal MS, shown in (c) of the figure, at the timing for driving a plurality of uppermost scanning lines of the display panel 1, and at the timing for driving a plurality of lowermost scanning lines. Thus, the mask signal is applied to pixels connected to the scanning lines instead of the display signal VS, each of the pixels being displayed in white. Furthermore, referring to FIG. 3, (a) is the horizontal sync signal, and (b) is the data line drive timing. The mask controlling circuit 16 outputs the control signal MS, shown in (c) of the figure, at the timing for driving a plurality of data lines from the left end and a plurality of data lines from the right end of the display panel 1. Thus, the mask signal is applied to pixels connected to the data lines instead of the display signal VS, each of the pixels being displayed in white.

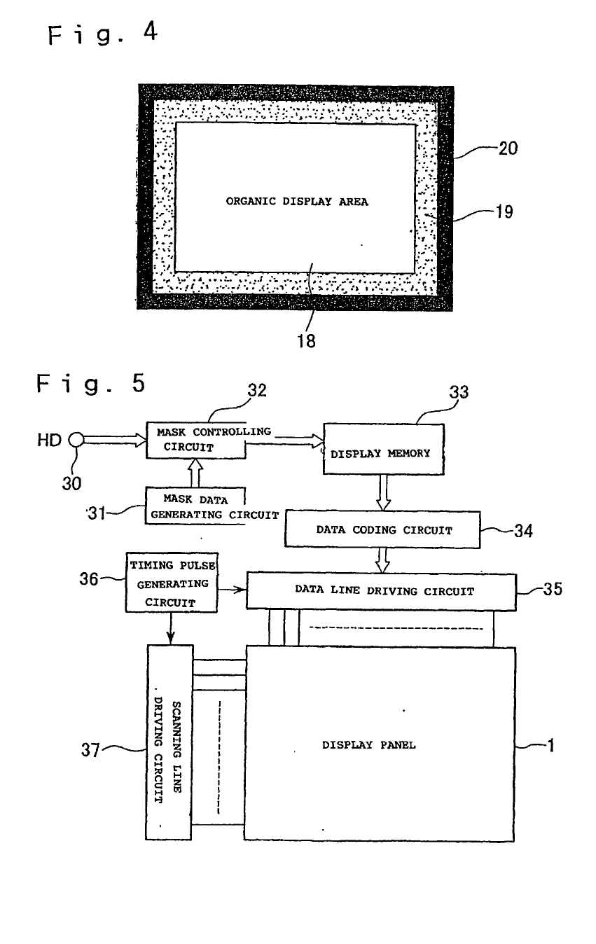

As described above, according to the above-described embodiment, the mask signal is applied to the pixels instead of the display signal VS at the timing for driving each of the pixels in the peripheral region of the display panel 1. Thus, as shown in FIG. 4, a white display area 19 is formed in the periphery of the active display area 18. Accordingly, the visibility in the peripheral region of the active display area 18 can be significantly improved compared with the conventional art. Referring to the figure, the numeral 20 is a light-blocking layer.

Next, a second embodiment of the present invention will be described. FIG. 5 is a block diagram showing the construction of a liquid crystal display apparatus according to a second embodiment of the present invention. Similarly to the liquid crystal display apparatus according to the above-described first embodiment, the liquid crystal display apparatus shown in the figure also displays white in the periphery of the active display area of the display panel 1. Furthermore, unlike the above-described apparatus, the liquid crystal display apparatus displays on the display panel 1 in gray scales by digital driving.

Referring to the figure, the numeral 30 is a terminal to which display data HD (digital data) is externally supplied, and 31 is a mask data generating circuit which constantly outputs mask data. The mask data is digital data hereinafter referred to as white display data) which instructs display in white. 32 is a mask controlling circuit, and 33 is a display memory. The display memory 33 is a memory which includes memory slots of a number which is the same as the number of the pixels, corresponding to each of the pixels one by one, and is rewritten each time a field is displayed. The mask controlling circuit 32 writes the display data HD to memory slots of the display memory 33 corresponding to the active display area 18 (FIG. 4), while writing the mask data output from the mask data generating circuit 31 to memory slots corresponding to the white display area 19.

A data coding circuit 34 reads out the display data in the display memory, converts each of the display data which has been read out into a pulse width, for example, using a conversion table which is internally provided, and outputs to a data line driving circuit 35. A timing pulse generating circuit 36 generates a scanning line driving signal and a data line driving signal based on system clock pulses, and respectively outputs to a scanning line driving circuit 37 and the data line driving circuit 35.

The scanning line driving circuit 37 outputs a “H” level signal sequentially to the first scanning line (the uppermost scanning line), the second scanning line, the third scanning line . . . , based on the timing of the scanning line driving signal. The data line driving circuit 35 outputs a “H” level signal having a pulse width in accordance with the display data sequentially to the first data line (the leftmost data line), the second data line, the third data line , based on the timing of the data line driving signal.

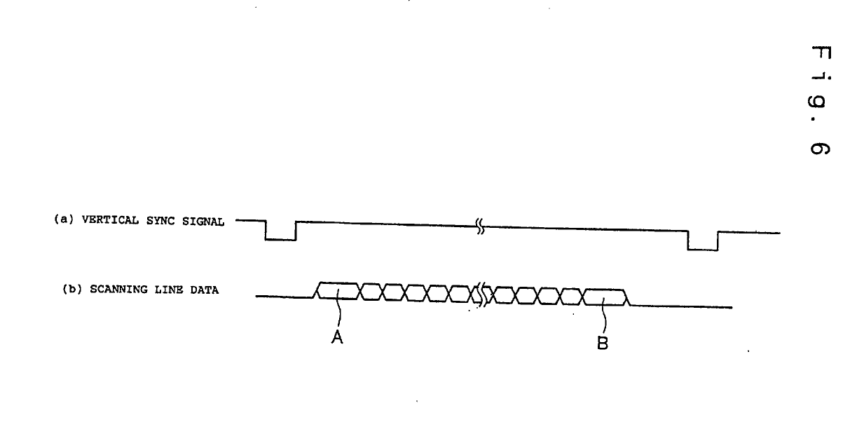

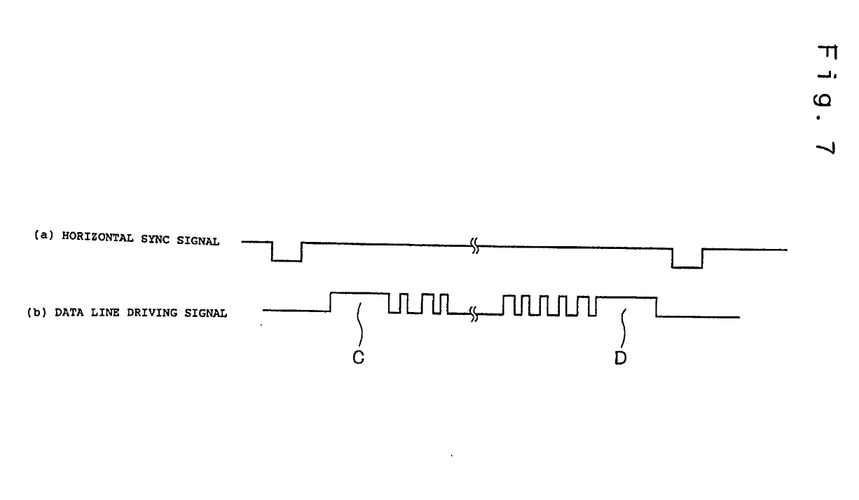

FIG. 6 (a) indicates the vertical sync signal, and (b) indicates the scanning line data. As described above, the white display data is written in the display memory 33. Thus, during the time when the plurality of uppermost scanning lines are scanned (see the character A) and during the time when the plurality of lowermost scanning lines are scanned (see the character B), each of the pixels connected to the scanning lines are displayed using the white display data. Furthermore, FIG. 7 (a) indicates the horizontal sync signal, and (b) indicates the data line driving signal. Also in driving the data lines, the drive signal for the plurality of data lines from the leftmost data line and a plurality of data lines from the rightmost data line is a signal having a pulse width for displaying white (the longest pulse width) (see the characters C and D).

As such, in the above-described embodiment, the white display data is constantly written to the memory slots in the display memory 33 corresponding to the white display area. Thus, similarly to the above-described liquid crystal display apparatus shown in FIG. 1, white color can be displayed in the peripheral region of the display area (see FIG. 4). Accordingly, the visibility in the peripheral region of the active display area can be improved.

Although in the above-described embodiment, the white display data is written to the display memory 33 each time the display memory is rewritten, alternatively, the white display data may be written in advance to predetermined memory slots of the display memory 33, so that only the other memory slots are rewritten with the display data each time a field is displayed. In this way, the construction of the mask controlling circuit 32 can be simplified.

Although the description has been directed to cases where the particular color which is displayed by the pixels in the peripheral region of the display area is white, the embodiments do not limit the particular color to white. For example, if the liquid crystal apparatus is a color display including color filters, depending on the display color of characters, etc., the display color which is displayed by the pixels in the peripheral region of the display area may be a color which facilitates recognition of the characters. For example, if the characters are displayed in yellow, the characters will be recognized with ease if the particular color which is displayed by the pixels in the peripheral region of the display area is black.

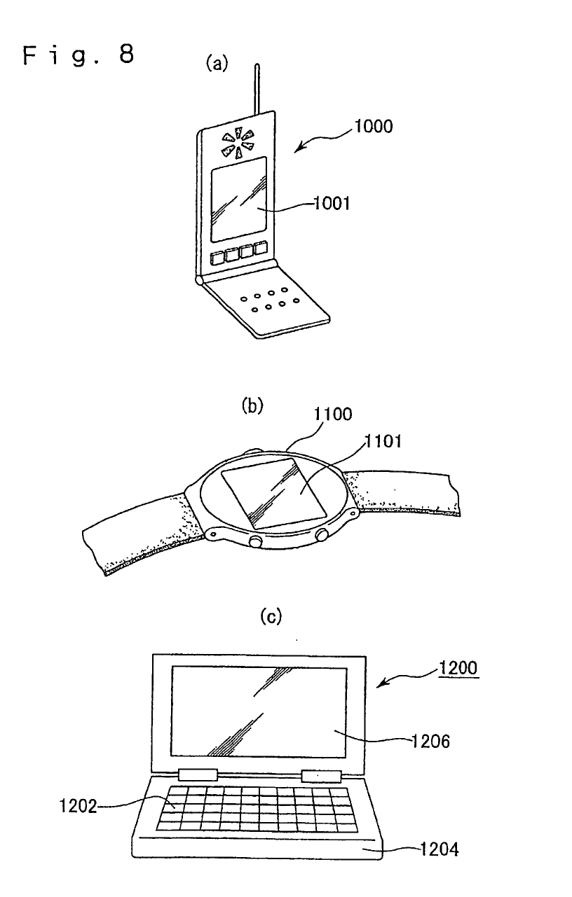

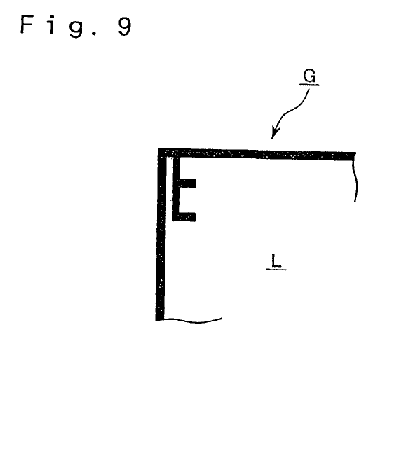

FIG. 8 is illustrations showing examples of application of the above-described embodiments, in which FIG. 8 (a) is a perspective view showing a cellular phone. 1000 indicates the main body of the cellular phone, in which 1001 is a liquid crystal display unit using a liquid crystal display apparatus according to the above-described embodiments. FIG. 8 (b) is an illustration showing an electronic apparatus of wristwatch type. 1100 is a perspective view showing the main body of the watch. 1101 is a liquid crystal display unit using a liquid crystal display apparatus according to the above-described embodiments. The liquid crystal display apparatus allows display with an improved visibility even in the peripheral region compared with a conventional watch display unit, allowing display of television images, and thus achieving a wristwatch-type TV.

FIG. 8 (c) is an illustration showing a portable information processing apparatus such as a word processor and a personal computer. 1200 indicates the information processing apparatus, 1202 an input unit such as a keyboard, 1206 a display unit using a liquid crystal display apparatus according to the above-described embodiments, and 1204 indicates the main body of the information processing apparatus.

### INDUSTRIAL APPLICABILITY

As described above, in accordance with the present invention, a particular color (e.g., white) is displayed in the periphery of the active display area of a display panel. Accordingly, the visibility in the peripheral region of the active display area can be significantly improved compared with the conventional art.

1. An electro-optical apparatus which comprises a display panel comprising a plurality of pixels, and driving means for driving each of the pixels of said display panel based on a display signal which is externally supplied,
said electro-optical apparatus comprising timing detection means for detecting the timing for driving the pixels in the peripheral region of said display panel, and display control means for outputting a signal for displaying a particular color to said driving means at the timing detected by said timing detection means.

2. An electro-optical apparatus which comprises a display panel comprising a plurality of pixels, and driving means for driving each of the pixels based on display data which is externally supplied corresponding to each of the pixels of said display panel,
said electro-optical apparatus comprising display control means for outputting to said driving means display data for displaying a particular color as display data for displaying each of the pixels in the peripheral region of said display panel.

3. An electro-optical apparatus which comprises a display panel comprising a plurality of pixels, a memory which stores display data corresponding to each of the pixels of said display panel, writing means for writing to said memory display data which is externally supplied, and driving means for driving each of said pixels based on the display data in said memory,
said electro-optical apparatus comprising display control means for writing to said memory display data for displaying a particular color as display data for displaying each of the pixels in the peripheral region of said display panel.

4. An electro-optical apparatus which comprises a display panel comprising a plurality of pixels, a memory which stores display data corresponding to each of the pixels of said display panel, writing means for writing to said memory display data which is externally supplied, and driving means for driving each of said pixels based on the display data in said memory,
characterized in that display data for displaying a particular color is stored in advance in a storage area of said memory corresponding to each of the pixels in the peripheral region of said display panel.

5. The electro-optical apparatus according to claim 1 to claim 4, characterized in that each of said pixels is composed of liquid crystal.

6. The electro-optical apparatus according to claim 1 to claim 5, wherein said particular color is white.

7. A method of driving an electro-optical apparatus which comprises a display panel comprising a plurality of pixels, and driving means for driving each of the pixels of said display panel based on a display signal which is externally supplied,
characterized in that the timing for driving the pixels in the peripheral region of said display panel is detected, and in that
a signal for displaying a particular color is output to said driving means at the detected timing.

8. A method of driving an electro-optical apparatus which comprises a display panel comprising a plurality of pixels, and driving means for driving each of the pixels based on display data which is externally supplied corresponding to each of the pixels of said display panel,
characterized in that display data for displaying a particular color is output to said driving means as display data for displaying each of the pixels in the peripheral region of said display panel.

9. A method of driving an electro-optical apparatus which comprises a display panel comprising a plurality of pixels, a memory which stores display data corresponding to each of the pixels of said display panel, writing means for writing to said memory display data which is externally supplied, and driving means for driving each of said pixels based on the display data in said memory,
characterized in that display data for displaying a particular color is written to said memory as display data for displaying each of the pixels in the peripheral region of said display panel.

10. The method of driving an electro-optical apparatus according to claim 7 to claim 9, wherein said particular color is white.
